(19) United States
(12) Patent Application Publication
(10) Pub. No.: US 2005/0239609 A1
(43) Pub. Date: Oct. 27, 2005

(54) Retractable link for pedal-driven apparatus

(76) Inventor: Chao-Chuan Chen, Taichung Hsien (TW)

Correspondence Address: BACON & THOMAS, PLLC, 625 SLATERS LANE, FOURTH FLOOR, ALEXANDRIA, VA, 22314, US

(21) Appl. No.: 10/831,183

(22) Filed: Apr. 26, 2004

(51) Int. Cl. A63B 69/16; B62M 1/00

(52) U.S. Cl. 482/57

(57) ABSTRACT

A retractable link is mounted on a pedal-driven apparatus, which is comprised of a pedal and a transmission axle, and is connected between the pedal and the transmission axle. The retractable link includes a first elongated link element having a sliding groove extended along its long axle, a second elongated link element longitudinally slidably mounted in the sliding groove, and lock means for locking the second elongated link element to the first elongated link element.

### BACKGROUND OF THE INVENTION

1. Field of the Invention

The present invention relates to a pedaling mechanism and more particularly, to a retractable link for use in a pedal-driven apparatus.

2. Description of the Related Art

Regular bicycles for transportation, stationary bicycles for exercise, as well as pedal-driven boats for tourists cruising on the lakes each commonly have a pedal-driven transmission mechanism. When in use, the user can pedal two pedals of the pedal-driven transmission mechanism to move the bicycle or pedal-driven boat.

However, those regular bicycles, stationary bicycles, and pedal-driven boats all have a common problem, i.e. the distance between the pedals and a transmission axle of the pedal-driven transmission mechanism is unchangeable for different users. For examples, when a tall user pedals the pedals, the user cannot keep the legs straight but bending the legs. While keeping the legs in a bending status for long, the user's legs may ache due to overexertion. When a short user pedals the pedals, the user must sit on the border area of the saddle in order to enable the feet to touch the respective pedals. If the user keeps pedaling the pedals by this manner for a period of time, the user will feel very uncomfortable.

In order to eliminate the aforesaid problem, the user may adjust the elevation that the saddle is positioned. The user can lift the saddle to increase the distance between the saddle and the pedals, or lower the saddle to reduce the distance between the saddle and the pedals. However, adjusting the elevation of the saddle simultaneously changes the distance between the saddle and a handhold means of an apparatus, such as handlebars in a bicycle or a hand wheel in a pedal-driven boat, affecting an angle that the user's hands hold the handhold means.

### SUMMARY OF THE INVENTION

The present invention has been accomplished under the circumstances in view. It is the primary object of the present invention to provide a retractable link for a pedal-driven apparatus; the retractable link is conveniently adjustable to fit different users.

To achieve the foregoing objects of the present invention, the retractable link of the present invention is mounted on the pedal-driven apparatus, which is comprised of a pedal and a transmission axle. The retractable link comprises a first elongated link element having a sliding groove extended along its long axle, a second elongated link element longitudinally slidably mounted in the sliding groove, and lock means for locking the second elongated link element to the first elongated link element.

### BRIEF DESCRIPTION OF THE DRAWINGS

FIG. 1 is a schematic view of a preferred embodiment of the present invention mounted on a stationary exercise bike.

FIG. 2 is an exploded view of the preferred embodiment of the present invention.

FIG. 3 is a perspective view of the preferred embodiment of the present invention.

FIG. 4 is a sectional view taken along a line 4-4 indicated in FIG. 3.

FIG. 5 is similar to FIG. 3, showing the length of a retractable link is adjusted.

FIG. 6 is similar to FIG. 1, showing the length of the retractable link is adjusted to shorten the distance between a pedal and a saddle of the exercise bike.

### DETAILED DESCRIPTION OF THE INVENTION

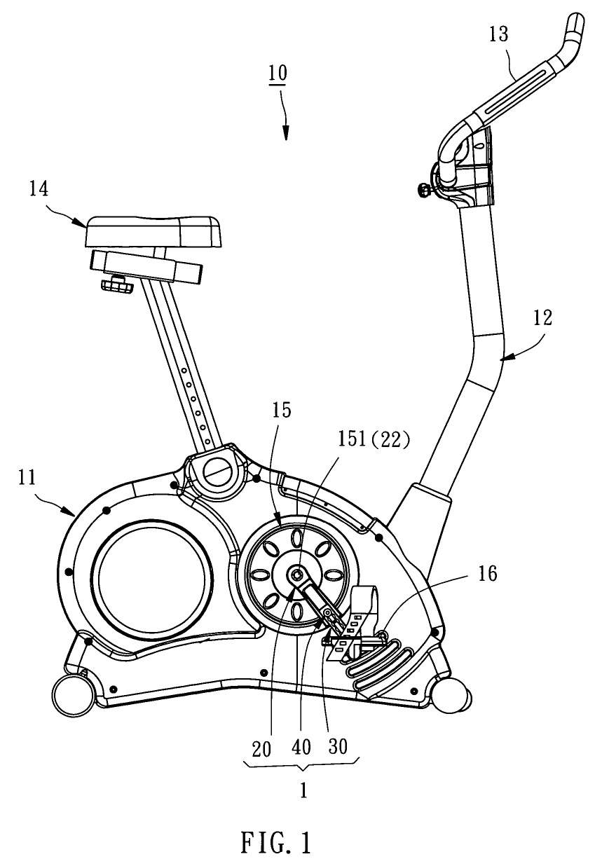

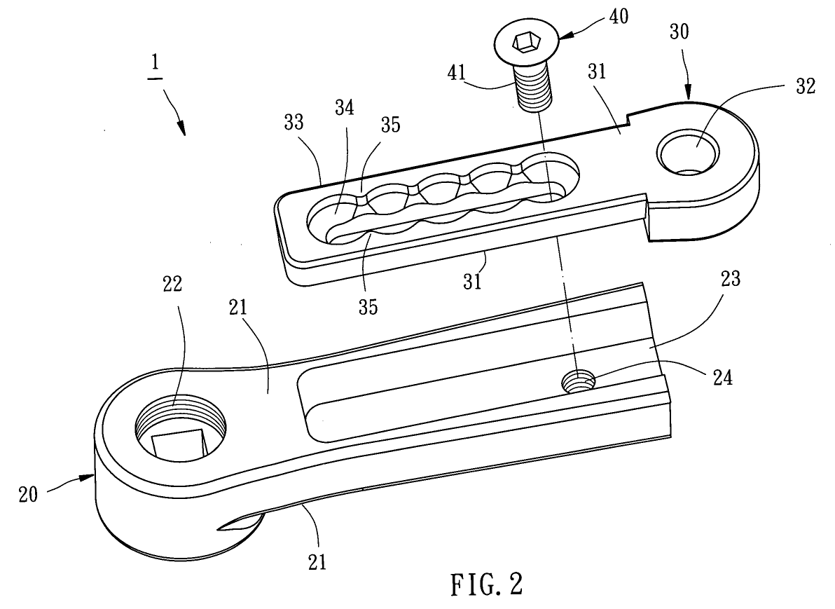

Referring to FIGS. 1-3, a stationary exercise bicycle 10 is comprised of a main body 11, a front bar 12 upwardly extended from a front side of the main body 11, two handlebars 13 mounted at a top side of the front bar 12, a saddle assembly 14 upwardly extended from a middle part of the main body 11 and spaced from the handlebars 13 for a distance, and a transmission mechanism 15 mounted in the main body 11 between the front bar 12 and the saddle assembly 14. Except the transmission mechanism 15, other parts of the stationary exercise bicycle 10 are less relevant to the disclosure of the present invention and will not be recited below.

The transmission mechanism 15 constructed according to the present invention includes two retractable links 1, and a rotary member which is embodied as a damping wheel (not shown) mounted inside the main body 11 of the stationary exercise bicycle 10. The rotary member has a transmission axle 151 and two pedals 16 each connected to an end of the transmission axle 151 via the retractable link 1 to be positioned at bilateral sides of the rotary member for pedaling by the user to rotate the damping wheel.

The retractable link 1 constructed according to a preferred embodiment of the present invention includes a first elongated link element 20, a second elongated link element 30, and lock means 40.

The first elongated link element 20 includes two opposite sidewalls 21, a coupling hole 22 formed at an end thereof and running through the two opposite sidewalls 21, a sliding groove 23 formed on one of the two opposite sidewalls 21 and extended along a long axle thereof, and a screw hole 24 running through the other of the two opposite sidewalls 21 and communicating with the sliding groove 23.

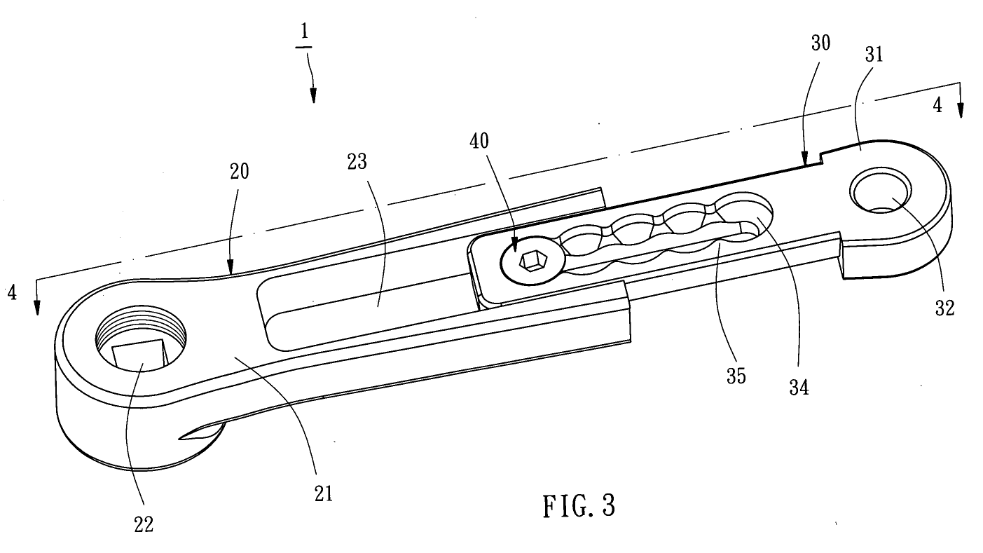

The second elongated link element 30 includes two opposite sidewalls 31, a coupling hole 32 formed at an end thereof and running through the two opposite sidewalls 31, an elongated connecting portion 33 formed at the other end thereof, five locating holes 34 serially aligned and partially overlapped on the elongated connecting portion 33, and a plurality of narrows 35 respectively formed between each two adjacent locating holes 34. The elongated connecting portion 33 has a cross-section fitting that of the sliding groove 23 of the first elongated link element 20. Further, the distance between a center of the first (left-side) locating hole 34 and a center of the last (right-side) locating groove 34 is 2 inches, i.e. maximum adjustable distance of the second elongated link element 30 relatively to the first elongated link element 20 is 2 inches. The design of the locating holes 34 and the narrows 35 is for multi-step adjustment (according to the present preferred embodiment, there are five steps). As shown in FIG. 3, the connecting portion 33 of the second elongated link element 30 is axially slidably inserted into the sliding groove 23 of the first elongated link element 20, keeping the coupling holes 22 and 32 located at two distal ends of the retractable link 1.

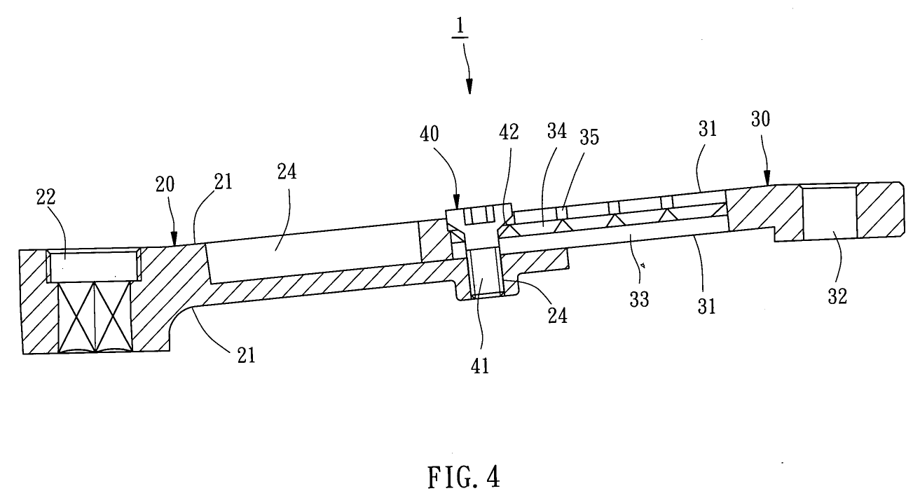

Referring to FIG. 4, the lock means 40 includes a threaded shank 41 and a stop portion 42 at an end of the threaded shank 41. The threaded shank 41 is inserted through one locating hole 34 of the second elongated link element 30 and threaded into the screw hole 24 of the first elongated link element 20 with the stop portion 42 engaged into the corresponding locating hole 34 and stopped against one or two narrows 35 of the second elongated link element 30 to stop the second elongated link element 30 from axial displacement relatively to the first elongated link element 20.

Referring to FIG. 1 again, the coupling hole 22 of the first elongated link element 20 is coupled to one end of the transmission axle 151 of the transmission mechanism 15 and then a lock member (not shown) is fastened to the transmission axle 151 to lock the first elongated link element 20 to the transmission axle 151, and the coupling hole 32 of the second elongated link element 30 is connected to one pedal 16 by a screw bolt and a nut. Thus, by means of the link 1, the pedal 16 can be pedaled to move the transmission mechanism 15.

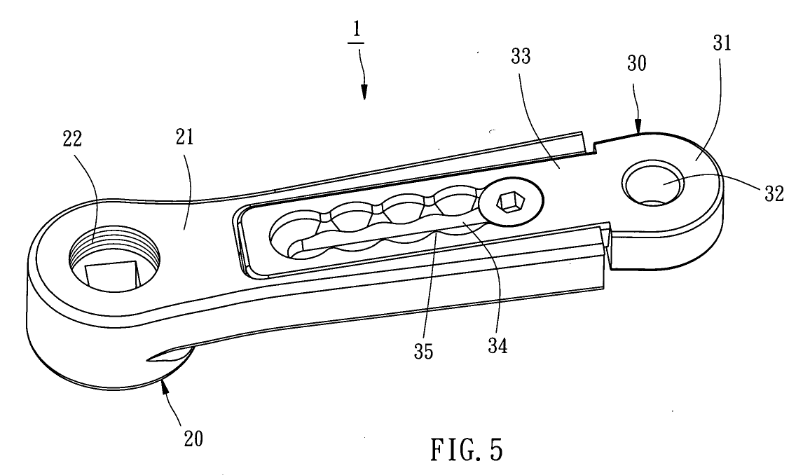

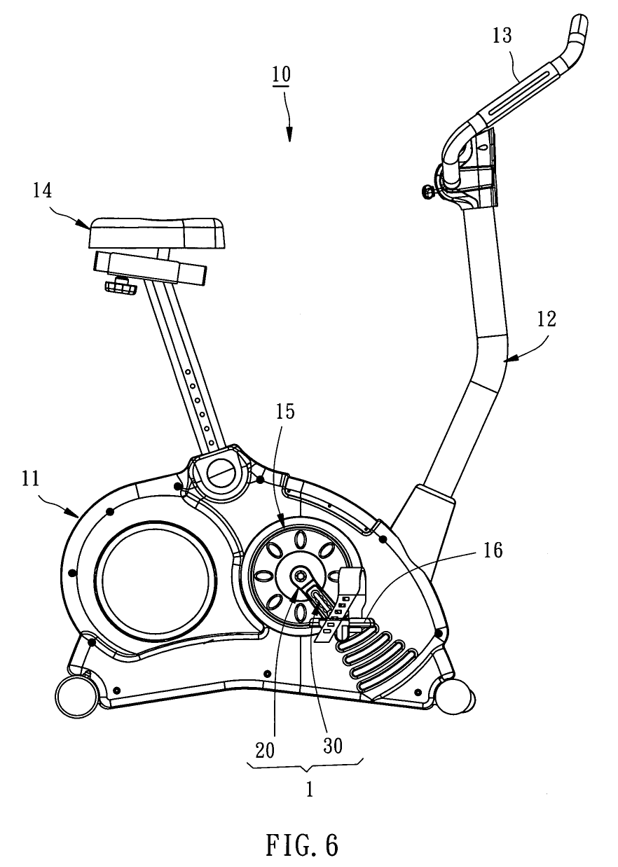

Referring to FIGS. 5 and 6, when a different user intends to operate the stationary exercise bicycle 10, loose the locating device 40 to move the stop portion 42 away from the corresponding locating hole 34 of the second elongated link element 30, and then move the second elongated link element 30 inwards or outwards relatively to the first elongated link element 20 to adjust the distance between the pedal 16 and the saddle assembly 14, and then thread the threaded shank 41 into the screw hole 24 to lock the retractable link 1. The length of the link 1 is increased or reduced by 0.4 inch when shifted the lock means 40 to the next locating hole 34.

As indicated above, the link 1 can be adjusted to change the distance between the respective pedal 16 and the saddle assembly 14, so that the user can pedal the pedals 16 of the exercise bicycle 10 smoothly and comfortably. Further, the user can also adjust the elevation that the saddle assembly 14 is positioned to extend the adjustment range of the distance between the respective pedal 16 and the saddle assembly 14, making the exercise bicycle 16 to fit the user's operating posture. Because the link 1 has a simple structure and is easy for operation, the user can easily adjust the distance between the pedals 16 and the saddle assembly 14.

Because the retractable link is adapted to allow the user to adjust the distance between the respective pedals and the saddle assembly, the joining arrangement between the first elongated link element and the second elongated link element is not limited to the aforesaid preferred embodiment, i.e. various modifications can be made. For example, the first elongated link element can be made to have a plurality of locating holes, and the lock means can be a retaining spring piece provided at the second elongated link element for optionally fastened to one of the locating holes of the first elongated link element.

Alternatively, the first elongated link element can be made to have a plurality of the locating holes; the second elongated link element can be made to have a receiving hole; the lock means can be made to have a spring member mounted in the receiving hole and a steel ball supported on the spring member for optionally engaging one of the locating holes of the first elongated link element.

In general, the retractable link of the present invention can be used in any of a variety of the pedal-driven apparatuses, like pedal-driven boat, cable bicycle, etc.

1. A retractable link mounted on a pedal-driven apparatus, said pedal-driven apparatus having a pedal and a transmission axle, said retractable link having two ends respectively connected with said transmission axle and said pedal, said retractable link comprising:
a first elongated link element having a sliding groove formed along a long axle thereof;
a second elongated link element slidably mounted in said sliding groove of said first elongated link element; and
lock means for locking said second elongated link element to said first elongated link element.

2. The retractable link as defined in claim 1, wherein said lock means comprises a screw bolt inserted through said second elongated link element and threaded into said first elongated link element.

3. The retractable link as defined in claim 2, wherein said first elongated link element comprises a screw hole; said second elongated link element comprises at least two locating holes; said screw bolt is optionally inserted through one of said locating hole and threaded into said screw hole.

4. The retractable link as defined in claim 3 wherein said locating holes are arranged in alignment and are partially overlapped to define a narrow between each two adjacent locating holes; said screw bolt comprises a stop portion for stopping against said corresponding narrow while being inserted into one of said locating holes.

5. The retractable link as defined in claim 3, wherein a distance between a center of a first one of said locating holes and a center of a last one of said locating holes is 2 inches.

6. A pedal-driven apparatus comprising a main body, a seat mounted at a top side of said main body, and a transmission mechanism mounted at a bottom side of said main body, said transmission mechanism having a rotary member and a retractable link, said rotary member having a transmission axle, said retractable link having two ends respectively connected with said transmission axle and a pedal, said retractable link comprising:
a first elongated link element having a sliding groove formed along a long axle thereof;
a second elongated link element slidably mounted in said sliding groove of said first elongated link element; and
lock means for locking said second elongated link element to said first elongated link element.

7. The pedal-driven apparatus as defined in claim 6, wherein said lock means comprises a screw bolt inserted through said second elongated link element and threaded into said first elongated link element.

8. The pedal-driven apparatus as defined in claim 7, wherein said first elongated link element comprises a screw hole; said second elongated link element comprises at least two locating holes; said screw bolt is optionally inserted through one of said locating hole and threaded into said screw hole.

9. The pedal-driven apparatus as defined in claim 8. wherein said locating holes are arranged in alignment and are partially overlapped to define a narrow between each two adjacent locating holes; said screw bolt comprises a stop portion for stopping against said corresponding narrow while being inserted into one of said locating holes.

10. The pedal-driven apparatus as defined in claim 8. wherein a distance between a center of a first one of said locating holes and a center of a last one of said locating holes is 2 inches.
